(19) United States
(12) Patent Application Publication
(10) Pub. No.: US 2011/0298696 A1
(43) Pub. Date: Dec. 8, 2011

(54) DISPLAYS WITH UNIFORM BACKLIGHT COLORS

(76) Inventors: Mingxia Gu, San Jose, CA (US); Jean-Jacques Drolet, San Ramon, CA (US)

(21) Appl. No.: 12/794,666

(22) Filed: Jun. 4, 2010

(51) Int. Cl. G09G 3/36; F21V 7/04

(52) U.S. Cl. 345/102; 362/606; 362/607

(57) ABSTRACT

Displays may include backlight structures. The displays may be liquid crystal displays for electronic devices such as computer monitors and computers. The backlight structures may include light-emitting diodes and a light-guide panel that has opposing first and second edges. The light-emitting diodes may inject light into the first edge of the light-guide panel. An edge reflector may be disposed along the second edge. The edge reflector may reflect more yellow light than blue light to enhance backlight color uniformity within the display. The edge reflector may be formed from a substrate that is impregnated with a colored substance or a multilayer structure. Light diffusing and light diffracting or refracting structures may be used to disrupt light emitted from a light-emitting diode before injecting the emitted light into a light-guide panel. Light-disrupting structures and blue-absorbing edge reflectors may be used together to promote backlight color uniformity in the backlight structures.

### BACKGROUND

This relates to displays for electronic devices, and, more particularly, to displays with uniform backlights.

Electronic devices often contain displays. For example, computer monitors and laptop computers contain displays. Displays are also present in televisions, cellular telephones, and other equipment.

Liquid crystal displays (LCDs) are used in many devices. A liquid crystal display typically includes a thin-film transistor layer and a color filter layer. The thin-film transistor layer contains transistors that are used in controlling the operation of the display. The color filter layer includes an array of colored filters that are used in imparting color to displayed images. A layer of liquid crystal material is interposed between the thin-film transistor layer and the color filter layer. Polarizer layers may be formed above and below the thin-film transistor layer and the color filter layer.

The thin-film transistor layer is associated with an array of electrodes. The array of electrodes may be used in forming images for an array of associated image pixels. During operation of the display, driver circuits on the thin-film transistor layer apply electric fields to the liquid crystal material using the array of electrodes. This changes the light polarization properties of the liquid crystal material and, in conjunction with the upper and lower polarizers in the display, modulates the transparency of the image pixels. By controlling the pattern of electric fields that are impressed upon the liquid crystal material, images may be displayed within the image pixel array.

In front-lit liquid crystal displays, the image pixels array is illuminated by light that strikes the exposed front surface of the display. In low-light conditions, it can be difficult or impossible to view images on front-lit liquid crystal displays.

To address the problems associated with front-lit displays, backlit displays have been developed. Backlit liquid crystal displays contain backlight structures. The backlight structures illuminate the image pixel array from its back surface. Because light is produced from within the display itself, backlit displays may be used in low-light conditions and other challenging lighting environments.

In a typical backlit display, a light guide panel is placed behind the thin-film transistor and color filter layers. A strip of light-emitting diodes (LEDs) produces light. The light-emitting diodes inject light into the light guide panel along one of its edges. Some of the light that is injected into light guide panel escapes from its front surface and serves as backlight for the display. Light that escapes from the rear surface of the light guide panel is redirected back out the front of the light guide panel using a back reflector. White or silver edge reflector structures may be used to minimize light leakage from the edges of the light guide panel.

The light-emitting diodes that are used in display backlight structures do not produce uniformly colored light. On-axis light from the light-emitting diodes tends to be bluer than off-axis light. As a result, the color of the backlight that is emitted from the backlight structures is not uniform. This lack of color uniformity can degrade the quality of images on the display. For example, the images on a display may be yellowish near their bottom edges and bluish near their top edges.

It would therefore be desirable to be able to provide displays such as backlight liquid crystal displays with enhanced color uniformity.

### SUMMARY

Electronic devices such as computer monitors, computers, and other electronic equipment may include displays such as liquid crystal displays. Backlights may be provided in the displays.

The backlights may include light sources such as light-emitting diodes. A backlight may have a light-guide panel formed form a polymer sheet or other transparent material. Light from the light-emitting diodes may be injected into an edge of the light-guide panel. The light that is injected into the light-guide panel may be scattered out of the panel to serve as backlight for an image pixel array in a display.

The light-emitting diodes may emit light that has different colors at different angles of emission. On-axis light may have be bluer than off-axis light. To avoid undesirable color gradients due to the angular variation of color in the light-emitting diodes, a backlight may include structures that promote backlight color uniformity.

The light-guide panel may have opposing first and second edges. The light-emitting diodes may inject light into the first edge of the light-guide panel. An edge reflector may be disposed along the second edge. The edge reflector may reflect more yellow light than blue light to enhance backlight color uniformity within the display.

The edge reflector may be formed from a substrate that is impregnated with a colored substance or a multilayer structure such as a structure having a reflective substrate and a yellow filter layer.

Light diffusing and light diffracting and light-refracting structures may be used to disrupt light emitted from a light-emitting diode before injecting the emitted light into a light-guide panel. The light diffusing structures may be formed from light diffusers that are attached to the edge of the light-guide panel with adhesive. The light-diffracting or light-refracting structures may be formed by angling edge portions of the light-guide panel or by attaching diffracting or refracting elements to the edge of the light-guide panel with adhesive.

Light-disrupting structures and blue-absorbing edge reflectors may be used simultaneously to promote backlight color uniformity in the backlight structures.

Further features of the invention, its nature and various advantages will be more apparent from the accompanying drawings and the following detailed description of the preferred embodiments.

### BRIEF DESCRIPTION OF THE DRAWINGS

FIG. 1 is a perspective view of an illustrative monitor that may be provided with backlit display structures in accordance with an embodiment of the present invention.

FIG. 2 is a perspective view of an illustrative electronic device such as a computer that may be provided with backlit display structures in accordance with an embodiment of the present invention.

FIG. 3 is an exploded perspective view of a display showing how a display may include light sources, a light guide panel, and an edge reflector in accordance with an embodiment of the present invention.

FIG. 4 is a front view of display structures that may be used in a display such as a strip of light-emitting diodes, a light guide panel, and an edge reflector in accordance with an embodiment of the present invention.

FIG. 5 is a cross-sectional side view of a display showing how the display may include a light guide panel, optical films, a light source such as light-emitting diodes, and an edge reflector in accordance with an embodiment of the present invention.

FIG. 6 is a cross-sectional side view of a light-emitting diode of the type that may be used in forming a light source for a backlit display in accordance with an embodiment of the present invention.

FIG. 7 is a cross-sectional side view of backlight structures for a display showing how light in a light guide panel is associated with light emanating from a light-emitting diode light source at different angles in accordance with an embodiment of the present invention.

FIG. 8 is a graph showing how the reflectivity spectrum of an edge reflector in a light guide panel may be configured to filter out light at short wavelengths to promote color uniformity in a display in accordance with an embodiment of the present invention.

FIG. 9 is a cross-sectional side view of an illustrative edge reflector based on a single layer of reflecting material in accordance with an embodiment of the present invention.

FIG. 10 is a cross-sectional side view of an illustrative edge reflector based on a multilayer configuration in accordance with an embodiment of the present invention.

FIG. 11 is a cross-sectional side view of an illustrative display showing how light from a light-emitting diode may be diffused using a diffuser before entering a light guide panel in accordance with an embodiment of the present invention.

FIG. 12 is a cross-sectional side view of an illustrative display showing how light from a light-emitting diode may be disrupted by virtue of a light-diffracting or light-refracting structure implemented with a light guide panel having an angled edge in accordance with an embodiment of the present invention.

FIG. 13 is a diagram of a portion of a conventional display showing how the edge of a conventional light guide panel may have a roughened region.

FIG. 14 is a diagram of a portion of a display that has been provided with an external diffusing element to help diffuse light from a light-emitting diode source before the light enters a light guide panel in accordance with an embodiment of the present invention.

FIG. 15 is a perspective view of a portion of a light guide panel with a curved edge that may be used to help disrupt light from a light-emitting diode in accordance with an embodiment of the present invention.

FIG. 16 is a perspective view of a light guide panel with a continuously scalloped edge that is receiving light from a light-emitting diode in accordance with an embodiment of the present invention.

FIG. 17 is a perspective view of a portion of a light guide panel to which a diffuser structure with a scalloped edge has been attached to help scramble light received from a light-emitting diode in accordance with an embodiment of the present invention.

FIG. 18 is a perspective view of a portion of a light guide panel having an angled edge that disrupts light received from a light-emitting diode in accordance with an embodiment of the present invention.

### DETAILED DESCRIPTION

This relates to backlight structures for displays. The displays in which the backlight structures are formed may be computer displays, television displays, displays for cellular telephones and other portable devices, computer monitor displays, or displays for other suitable electronic devices.

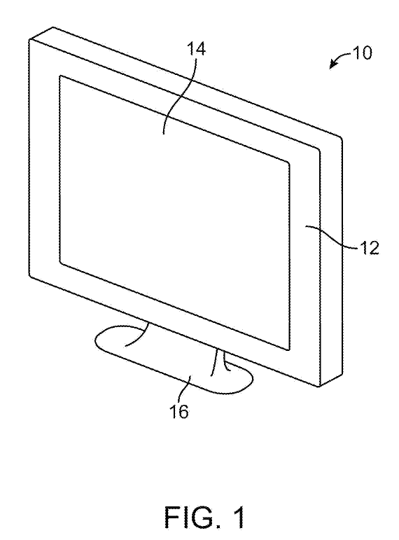

An illustrative computer monitor is shown in FIG. 1. As shown in FIG. 1, computer monitor 10 may have a display such as display 14 that is mounted in housing 12. Support structure 16 may be used to support monitor 10.

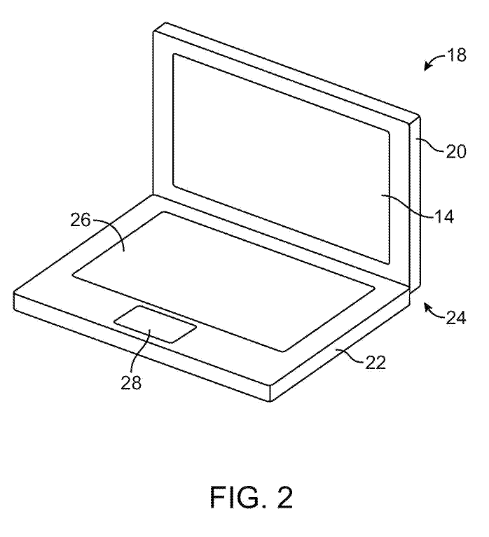

An illustrative portable computer with a display is shown in FIG. 2. As shown in FIG. 2, computer 18 may have an upper housing portion such as upper housing 20 and a lower housing portion such as lower housing 22. Display 14 may be mounted in upper housing 20. Upper housing 20 may be connected to lower housing 22 using hinge 24. Lower housing 22 may include user interface devices such as keyboard 26 and touchpad 28. If desired, touch functionality may be incorporated into display 14 of FIG. 2, display 14 of FIG. 1, or other displays. For example, an array of transparent capacitor electrodes may be included in display 14. The capacitor electrodes may be used to implement a capacitive touch sensor array for display 14.

Displays such as displays 14 of FIGS. 1 and 2 may, in general, be mounted in any suitable electronic device. The examples of FIGS. 1 and 2 are merely illustrative.

Display 14 may be, for example, a liquid crystal display (LCD). Display 14 may be provided with a backlight. The backlight may illuminate the pixels of display 14 from the backside (interior) surface of display 14. This allows display 14 to be used to display images for a user even when there is no ambient light available.

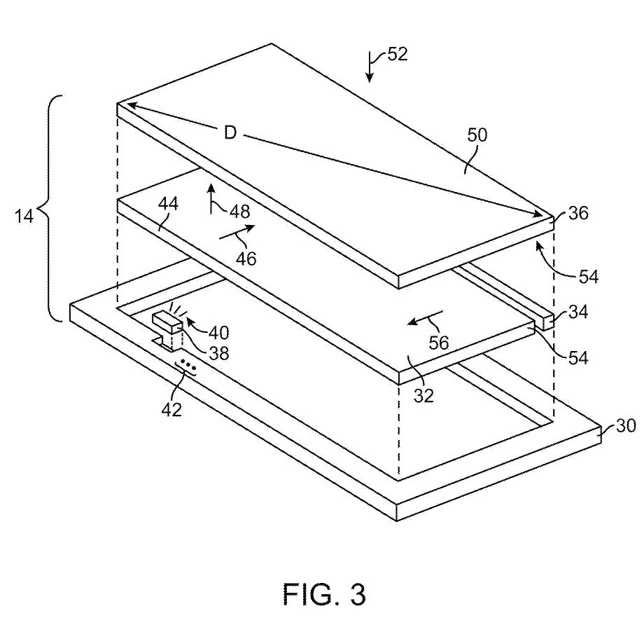

An exploded perspective view of display 14 showing some of the backlight structures that may be used in display 14 is shown in FIG. 3. As shown in FIG. 3, display 14 may include housing structures 30, backlight structures 32, and display layers 36.

Display structures 36 may include an array of image pixels. The image pixels may be controlled to display images on display 14. With one suitable arrangement, which is sometimes described herein as an example, display structures 36 form part of a liquid crystal display (LCD) and include a thin-film transistor layer, a color filter layer, and a layer of liquid crystal material. Driver circuitry may use transistor circuits on the thin-film transistor layer and associated electrodes to produce a desired pattern of electric fields in the liquid crystal material, thereby creating a desired image for the display.

Display structures 36 contains an array of image pixels whose transparency is controlled the driver circuits for display 14. When displaying an image, light passes through display structures 36 and is viewed by a user.

In a front-lit structure, light would enter the display from the front (e.g., display structures 36 would be illuminated by light entering front surface 50 in direction 52). In backlit configurations of the type shown in FIG. 3, illumination is provided from within the display (e.g., display structures 36 are illuminated by directing light onto back surface 54 of display structures 36 in direction 48).

Display structures 36 and other display components may be mounted using housing structures 30. Housing structures 30 may be formed from plastic, metal, composites, other materials, or combinations of these materials. Housing structures 30 may be formed as integral parts of device housings such as housing 12 of FIG. 1 and housing 20 of FIG. 2 or may be implemented using frame or chassis structures that are mounted within a device housing. For example, structures 30 may include plastic and metal chassis members.

Backlight structures in display 14 may include a reflective rear layer (not shown in FIG. 3) and light guide panel 32. Light guide panel 32 may be formed from a transparent (translucent) material. Light guide panel 32 may, for example, be formed from a sheet of polymer (e.g., polymethyl methacrylate, polycarbonate, other plastics, etc.). Light guide panel 32 may be 2-6 mm thick, 1-8 mm thick, more than 3 mm thick, less than 3 mm thick, etc. The size of display 14 (i.e., diagonal dimension D) may be less than 3 inches, 3-7 inches, greater than 7 inches, greater than 10 inches, greater than 13 inches, 13 to 17 inches, greater than 17 inches, etc.

Backlight for display 14 may be provided by light sources such as light-emitting diodes. Light-emitting diodes such as light-emitting diode 38 of FIG. 3 may be mounted in housing structures 30 or other suitable support structures. As indicated by dots 42, there may be more than one light-emitting diode in a given display. There may be, for example, 2-10 light emitting diodes in display 14, 10-30 light-emitting diodes in display 14, 30-70 light-emitting diodes in display 14, or more than 70 light-emitting diodes in display 14. As an example, in a display having a diagonal dimension D in the range of 20-30 inches, there may be 30-70 light-emitting diodes 38 (as an example). Light emitting diodes 38 may be about 1-3 mm in length (as an example).

Light-emitting diodes 38 may inject light 40 into edge 44 of light guide panel 32. Some light is carried internally in panel 32 in direction 46 in accordance with the principle of total internal reflection. As light 40 travels in direction 46, some of the light is scattered out of light guide panel 32 in direction 48 and serves as backlight for display 14. Some of the light that is traveling in direction 46 reaches far edge 54 of light guide panel 32 (i.e., the edge of panel 32 that is opposite to edge 44). To reduce light leakage, display 14 may be provided with edge reflectors along some or all of the edges of light guide panel 32. As shown in FIG. 3, for example, display 14 may be provided with an edge reflector such as reflector 34. Reflector 34 can reflect light that is traveling in direction 46 back into light guide panel 32 in direction 56. As the reflected light travels within light guide panel 32, some of the reflected light will be scattered in direction 48 and will serve as additional backlight for display 14.

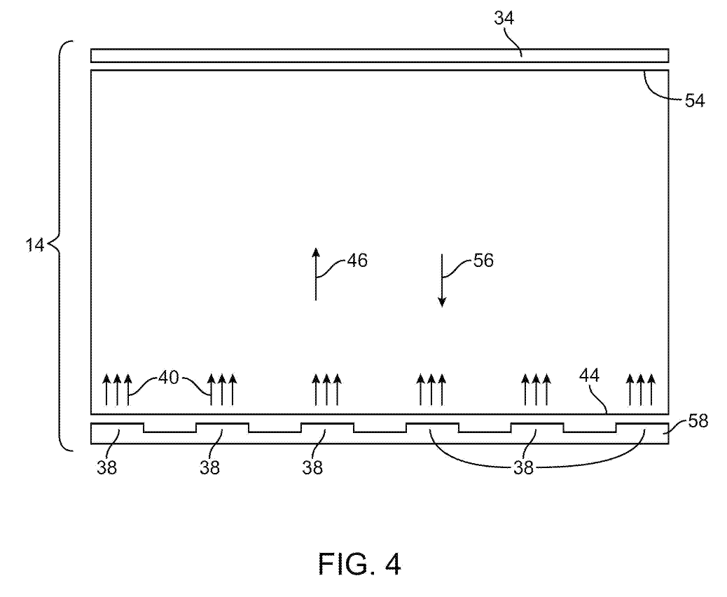

A front view of display 14 showing how backlight for the display may be provided by a strip of light-emitting diodes 38 is shown in FIG. 4. As shown in FIG. 4, light 40 may be emitted from each light-emitting diode 38 in light-emitting diode strip 58. Strip 58 may include any suitable number of light-emitting diodes. The illustrative configuration of FIG. 4 in which strip 58 has six light-emitting diodes is merely illustrative. Strip 58 may have an integral plastic member or other support that carries multiple light-emitting diodes. When oriented so that the tops of light-emitting diodes 38 each face edge 44 of light-guide panel 32, light 40 from the light-emitting diodes of strip 58 can be emitted into edge 44 of light-guide panel in direction 46 and can travel to opposing edge 54 of light-guide panel 32. Edge reflector 34 can reflect light that has reached opposing edge 54 in direction 56, thereby reducing light leakage out of the edges of display 14.

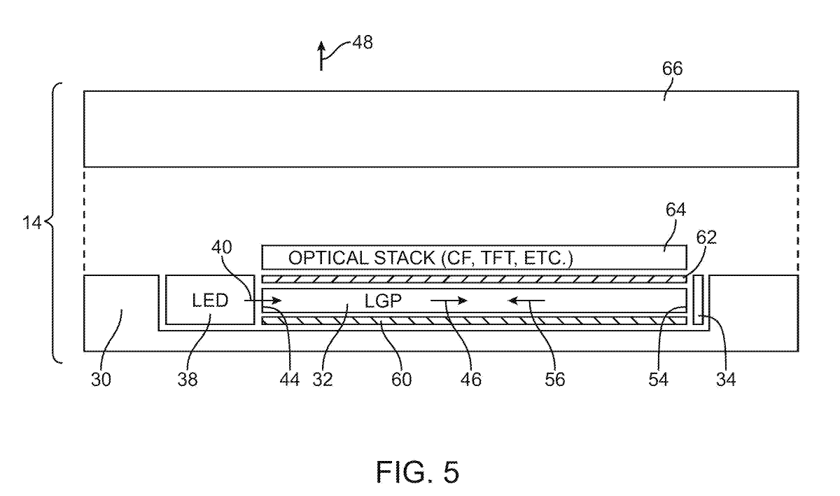

FIG. 5 is a cross-sectional side view of display 14 showing how display 14 may include layers of optical structures. As described in connection with FIG. 3, display 14 may include housing 30, light emitting diodes such as light-emitting diode 38, and a light-guide panel such as light-guide panel 32. A back reflector such as reflective layer 60 may be placed below light-guide panel 32. Reflective layer 60 may be formed from a sheet of metal, a sheet of polymer coated with metal, or other reflective structures. Back light films 62 may be placed above light-guide panel 32. Back light films 62 may include optical structures such as a diffuser layer, a prism sheet, a polarizer sheet, etc. Structures such as backlight optical films 62, light-guide panel 32, and reflective layer 60 are sometimes collectively referred to as the “backlight” for display 14.

Optical stack 64 may be formed above the backlight in display 14. Optical stack 64 may include structures such as a color filter layer, a thin-film transistor layer, a polarizer layer, other optical films, etc. Optical stack 64, the backlight structures formed from layers 62, 32, and 60, and support structures 30 are sometimes collectively referred to as a display module. The display module portion of display 14 may be protected by a cover layer such as cover layer 66. Cover layer 66 may be formed from plastic, glass, or other transparent structure that allow images to pass to the exterior of display 14 in direction 48. If desired, a touch sensor array may be included in the layers of display 14. For example, an array of capacitor electrodes formed from a transparent material such as indium tin oxide may be used to form a capacitive touch sensor for display 14.

As shown in FIG. 5, light 40 from light-emitting diodes 38 that is emitted into edge 44 of light-guide panel 32 in direction 46 may, upon reaching opposing edge 54 of light-guide panel 32, be reflected back into light-guide panel 32 in direction 56 by edge reflector 34. This prevents light from leaking out of edge 54 and thereby improves backlight efficiency.

Light-emitting diodes such a light-emitting diode 38 are preferably white-light diodes that emit light across substantially all of the visible spectrum. The use of white light allows the color filter elements in the color filter array of display 14 to be used in producing image pixels of desired colors (e.g., red, green, and blue).

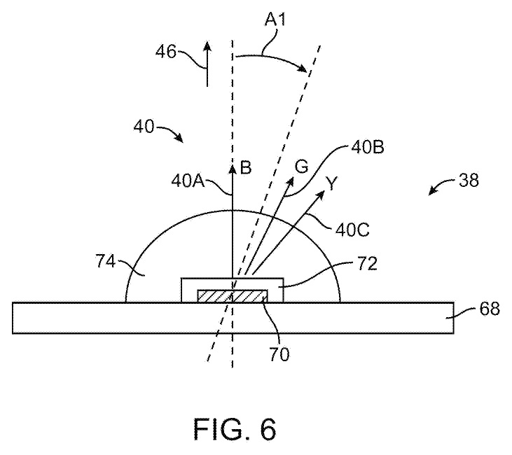

A cross-sectional side view of an illustrative light-emitting diode such as light-emitting diode 38 is shown in FIG. 6. As shown in FIG. 6, light-emitting diode 38 may include light-emitting diode semiconductor chip 70 formed on a substrate such as substrate 68. Substrate 68 may be, for example, a printed circuit board substrate. Light-emitting semiconductor chip 70 may be, for example, a blue light-emitting diode chip that produces blue light. Light-emitting diode chip 70 may be covered with a phosphorescent material such as phosphor 72 that converts the blue light that is produced by light-emitting diode 70 into white light (i.e., light that contains components across the entire visible spectrum). A dome structure such as light-emitting diode dome 74 may be used to cover phosphor 72 and chip 70.

Light-emitting diodes with configurations of the type shown in FIG. 6 are subject to the so-called color over angle (COA) effect. The path length of the light that passes through phosphor 72 is not equal at all angles A1 with respect to primary light emission direction 46 (i.e., the normal axis that extends perpendicular to the planar surface of chip 70). Light that is emitted along direction 46 passes through less phosphorescent material than off-axis light. As a result, on-axis light (light emitted parallel to direction 46) tends to remain blue, whereas off-axis light (light emitted at a non-zero angle with respect to on-axis direction 46) is converted sufficiently to produce yellow light.

Light at different angles therefore has different respective colors. This is illustrated in the FIG. 6 example. As shown in FIG. 6, on-axis light ray 40A, which makes an angle A1 of 0° with respect to primary light emission axis 46, tends to be blue (as indicated by the color label “B” in FIG. 6). Off-axis light ray 40B, which makes an angle A1 of about 30° with respect to primary light emission axis 46, tends to be green (as indicated by the color label “G” in FIG. 6). Off-axis light ray 40C, which makes an angle A1 of about 45° with respect to primary light emission axis 46, tends to be primarily yellow (as indicated by the color label “Y” in FIG. 6). In general, different diodes may have different angle-dependent color distributions. The example of FIG. 6 is merely an example.

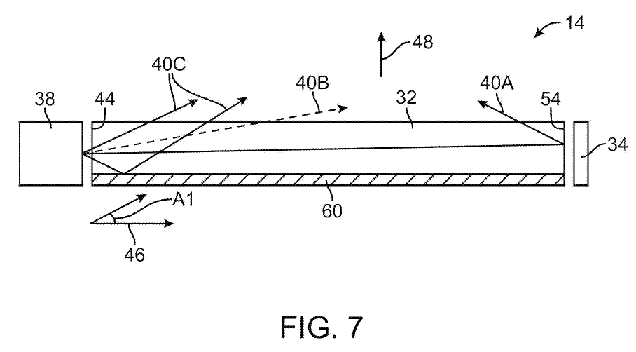

As shown in FIG. 7, the dependence of the color of emitted light 40 on angle A1 may affect the way in which backlight is distributed within display 14. On-axis light such as light ray 40A tends to penetrate further into light-guide panel 32 before scattering in direction 48. This light tends to be scattered in direction 48 in the vicinity of far edge 54. Off-axis light that is oriented at moderate angles A1 with respect to axis 46 may be emitted from light-guide panel 32 near the middle of light-guide panel 32 (i.e., midway between edges 44 and 54). Off-axis light that is emitted at steep off-axis angles A1 such as light ray 40C is scattered in direction 48 in the vicinity of edge 44 of light-guide panel 32.

If care is not taken, the angle dependence of the color emitted by light-emitting diodes in a backlit display may adversely affect color uniformity. In conventional displays, the edge reflector on the far side of the light-guide panel is made from a spectrally neutral material such as white paper (i.e., the reflectivity of the edge reflector is flat and unvarying across the visible spectrum). As a result, the spectrum of the light that reflects from the edge reflector in conventional light-guide panels remains blue. Conventional displays therefore tend to exhibit color gradients, being yellow near the edge of the display where light is injected into the light-guide panel and blue near the opposing edge.

By incorporation of appropriate color-gradient-compensation features, the color gradient backlight problem in conventional displays can be overcome. One type of color-gradient compensation feature that can help prevent undesired backlight color gradients involves use of edge reflectors 34 with non-flat reflectivity spectrums. For example, edge reflector 34 may be formed from a yellow material such as yellow paper or other materials that reflect a reduced amount of blue light relative to yellow light. When edge reflector 34 is implemented using a yellow reflector structure, the blue component of the light that reflects from reflector 34 in the vicinity of edge 54 is reduced relative to the yellow component of the light that reflects from reflector 34. This helps eliminate the yellow-to-blue gradient that is present in conventional displays and thereby enhances color uniformity.

The edge reflector may have any suitable color (yellow, yellowish green, green, etc.), provided that the reflectivity spectrum of the edge reflector tends to absorb more light near the blue end of the visible spectrum than at longer visible wavelengths (i.e., yellow wavelengths and red wavelengths). Factors that may influence optimum selection of the reflectivity spectrum for edge reflector 34 include the size of display 14, the thickness of light guide panel 32, the absorption spectrum of the bulk material from which light guide panel 32 is formed, the characteristics of light-emitting diodes 38 such as the dependence of emitted light color on angle of emission, etc.

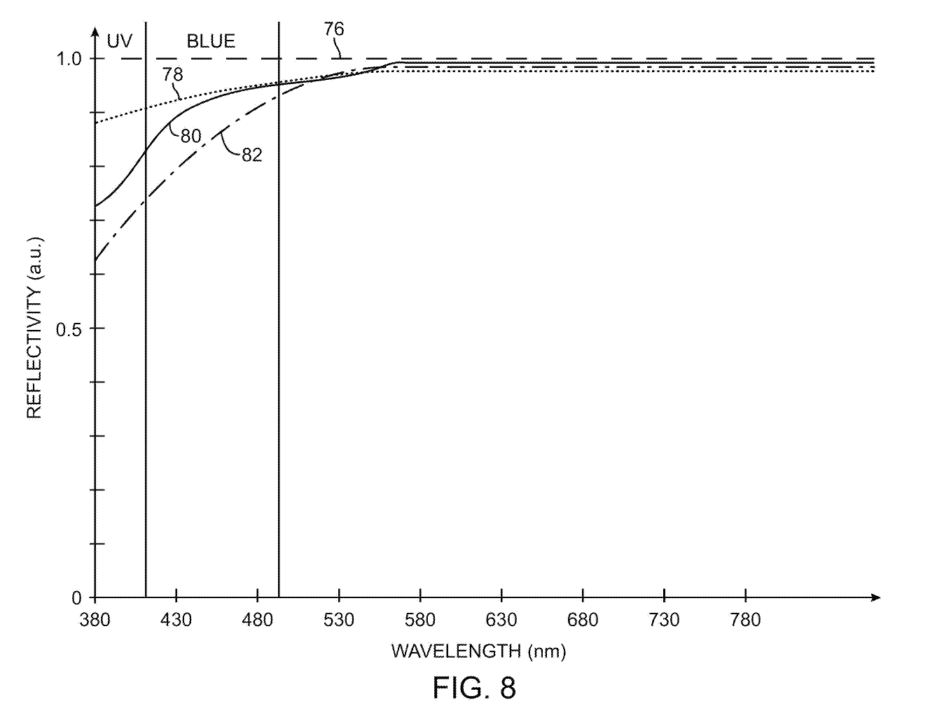

Illustrative reflectivity characteristics that may be used for reflector 34 are shown in FIG. 8. In the example of FIG. 8, the reflectivity spectrum of a conventional (white paper) reflector is shows by dashed line 76. As shown, dashed line 76 is flat, because the amount of light reflected from a conventional white paper edge reflector does not vary significantly as a function of wavelength. Lines 78, 80, and 82 represent three different illustrative reflectivity characteristics that may be used for edge reflector 34. Each of lines 78, 80, and 82 corresponds to an edge reflector with a blue-filtering (blue-absorbing) characteristic. Light with wavelengths in the range of about 400-500 nm corresponds to blue light. Light with wavelengths longer than 500 nm corresponds to other colors (green, yellow, orange, red). For example, yellow light has a wavelength of about 570 nm. Edge reflectors with reflectivity characteristics such as lines 78, 80, and 82 absorb more blue light (i.e., light in the visible wavelength range of 400-500 nm or at the blue wavelength of about 475 nm) than light at longer wavelengths (i.e., more light than at the yellow wavelength of 570 nm, more light than at wavelengths longer than 500 nm, more light than at wavelengths in the range of 500-780 nm, and more light than at wavelengths in the range of 600-700 nm, etc.).

Line 78 corresponds to filter characteristic with relatively little blue light absorption (i.e., about 10%). The reflectivity spectrum associated with line 80 indicates that blue light is cut by about 15% relative to light at longer wavelengths. The example of line 82 corresponds to an edge reflector with a significant blue filtering capability. Up to 30% of the light in the blue portion of the spectrum that reaches an edge reflector having the reflectivity characteristic of curve 82 will be absorbed rather than reflected. These examples are merely illustrative. Other filter characteristics may be used for edge reflector 34 if desired, provided that shorter visible wavelengths are absorbed more (preferably by at least 3% more or at least 10% more) than longer visible wavelengths.

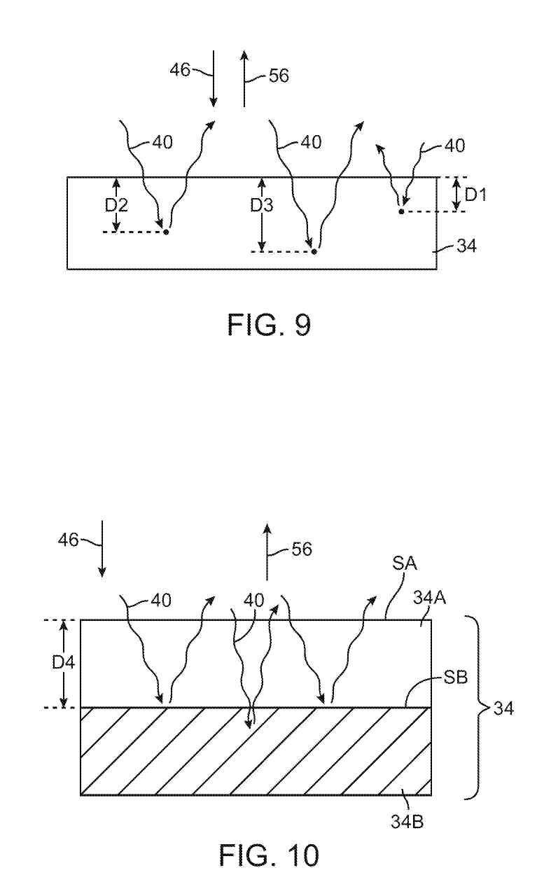

Edge reflector 34 may be implemented using any suitable structures. For example, edge reflector 34 may be implemented using dyed paper (e.g., white paper or other substrate material that has been impregnated with yellow dye, other colored pigment, or other colored substances). In this type of arrangement, incoming light 40 tends to travel various distances into the bulk of edge reflector 34 before being reflected. A cross-sectional side view of an illustrative edge reflector 34 that has been formed using this type of arrangement is shown in FIG. 9. As shown in FIG. 9, an edge reflector formed from a solid reflective material allows light 40 to penetrate to a variety of depths (e.g., depth D1, depth D2, and depth D3 in the FIG. 9 example) before being reflected in direction 56.

FIG. 10 is a cross-sectional view of an edge reflector formed from multiple layers of material. In the FIG. 10 example, edge reflector 34 has first layer 34A and second layer 34B. First layer 34A has a surface SA that receives incoming light 40 that is propagating in direction 46. First layer 34A also has a buried surface SB at the interface between layer 34A and 34B. Layer 34B may be formed from a reflective substrate material such as white paper or other substance that reflects light. Layer 34A may be formed from yellow-tinted transparent material. Layer 34A may, for example, be formed from a yellow filter material such as yellow plastic or other blue-absorbing color filter material). With this type of arrangement, incoming light 40 tends to pass completely through filter layer 34A before striking reflector 34B. Some light 40 will penetrate into the bulk of layer 34B, whereas other light 40 (e.g., the light rays shown in FIG. 10) will tend to reflect off of layer 34B at interface SB (i.e., at a depth of D4 beneath surface SA).

The blue-absorbing edge reflector designs of FIGS. 9 and 10 are merely illustrative. Any suitable edge reflector configuration may be used for reflector 34 if desired (e.g., single-layer structures, structures with two or more layers, structures that include dyes and other colored materials that impart filtering characteristics on reflector 34, structures that include alternating high-low dielectric stacks that impart filtering characteristics on reflector 34, layers of metal, layers of paper, layers of plastic, metallic coatings, dye-based coatings, paint, etc. The illustrative edge reflector structures of FIGS. 9 and 10 are presented as examples. In a typical arrangement, edge reflector 34 is provided as a separate structure. If desired, edge reflector 34 may be integrated into other structures in display 14 (e.g., device housing structures, display housing structures, plastic chassis or metal chassis structures, coatings on the edge of a light-guide panel, etc.).

Color uniformity in display 14 may also be enhanced by disrupting the angles of the light rays emanating from light emitting diodes 38. This type of light scrambling approach will tend to divert some of the on-axis blue rays into off-axis paths while diverting some of the off-axis yellow rays into on-axis paths. Because blue rays are typically emitted in on-axis directions and yellow rays are typically emitted in off-axis directions as described in connection with FIG. 6, disruption of the angles of the light rays emanating from light emitting diode 38 will tend to tend to reduce any angular dependence of the color of light 40.

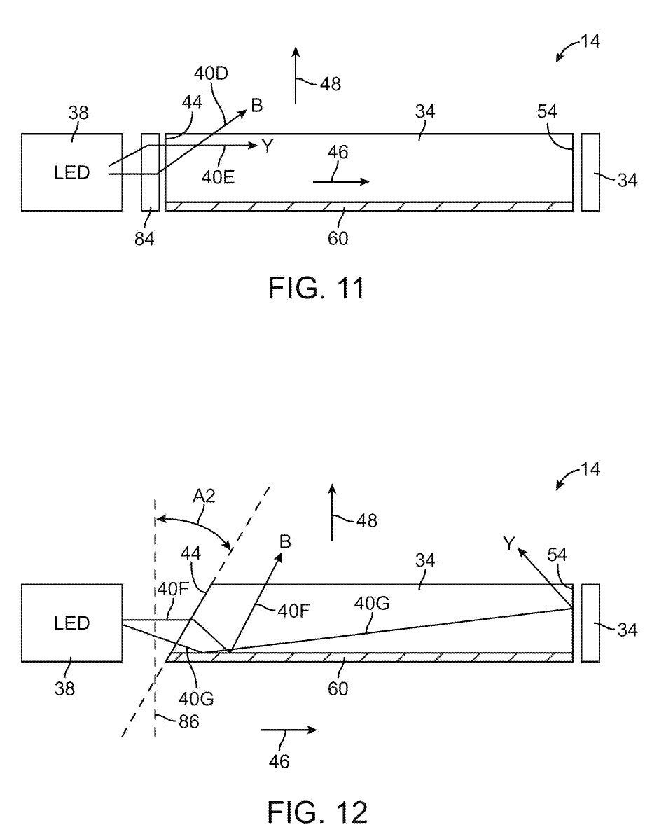

FIG. 11 is a cross-sectional diagram of an illustrative light disrupting configuration that is based on a diffuser. As shown in FIG. 11, light diffuser 84 may interposed between light-emitting diode 38 and light-guide panel 32. Due to the angle-dependent color characteristics of light-emitting diode 38, blue rays such as ray 40D are generally emitted in on-axis directions (i.e., direction 46) and yellow rays such as yellow ray 40E are generally emitted in off-axis directions. When these rays strike diffuser 84, however, the diffusing action of diffuser 84 causes light to scatter. As a result, blue ray 40D may be scattered upwards in direction 48 in the vicinity of edge 44, whereas yellow ray 40E may be scattered so that it propagates along axis 46 and is scattered upwards in direction 48 nearer to edge 54. The diffusing properties of diffuser 84 therefore tend to reduce the yellow-blue color gradient of conventional backlights. If desired, diffuser 84 may be used in conjunction with a blue-absorbing edge reflector (e.g., edge reflector 34 of FIG. 11 may have one of the tilted absorption profiles shown in FIG. 8).

Diffuser 84 may be formed from one or more layers of material such as layers of translucent plastic, glass, or other transparent materials. If desired, light rays 40 can be disrupted by using optical structures that diffract (e.g., structures that alter the light as it encounters those structures) or refract (e.g., structures that alter the light as its speed changes through various media) light at edge 44. For example, light-guide panel 32 may be provided with an angled edge, such as angled edge 44 in FIG. 12. As shown in FIG. 12, edge 44 may be oriented at a non-zero angle A2 with respect to axis 86. Axis 86 may lie in the plane of substrate 68 (FIG. 6). Angle A2 may be, for example, 5-60°, 15-50°, or 30-45° (as examples).

When an on-axis blue light ray such as ray 40F strikes edge 44, this blue light ray may be diffracted or refracted downwards away from direction 48 and may thereafter be reflected upwards in direction 48 by reflector 60 in the vicinity of edge 44. An off-axis yellow light ray such as ray 40G may be diffracted or refracted less when reaching surface 44 due to the more perpendicular orientation of rays such as ray 40G with respect to surface 44. As a result, off-axis ray 40G may be reflected in a direction that is more aligned with on-axis direction 46, causing off-axis yellow ray 40G to be scattered upwards nearer to far edge 54 of display 14 (e.g., after being reflected from edge reflector 34). The use of angled edge 44 may therefore tend to increase the amount of blue backlight near edge 44 and the amount of yellow backlight near edge 54, counteracting the color gradient expected from use of light-emitting diode 38 in a conventional configuration.

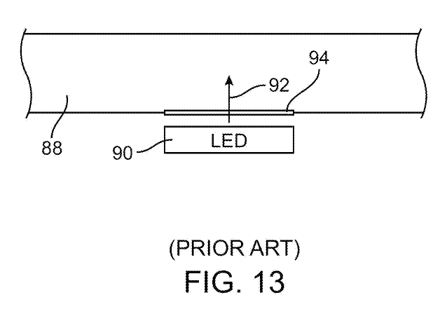

Conventional light-guide panels sometimes have roughened edges to facilitate light coupling from light-emitting diodes. As shown in FIG. 13, conventional light-guide panel 88 has roughened surface 94 in the vicinity of light-emitting diode 90. Surface 94 may have surface pits and bumps of about one micron in size. The presence of surface 94 may help diffuse light 92 from light-emitting diode 90. However, the process of forming roughened surfaces on light-guide panels using arrangements of the type shown in FIG. 13 may lead to the undesirable generation of particulates and a corresponding need to clean the light-guide panel.

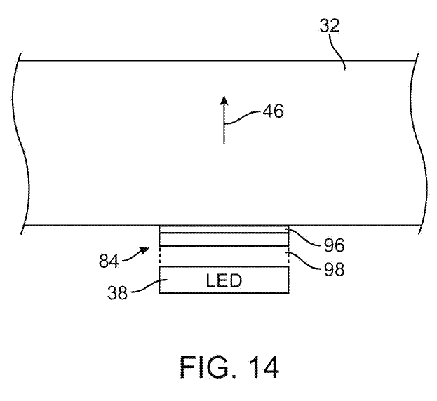

As shown in FIG. 14, a diffuser of the type shown in FIG. 11 (diffuser 84) may be attached to edge 44 of light guide panel 32 using adhesive 96. Diffuser 84 may, for example, be implemented as a strip of plastic. The strip of plastic or other material that makes up diffuser 84 may be attached along part of edge 44 of light guide panel 32 or may run along substantially all of edge 44 (as examples).

Adhesive 96 may be liquid adhesive (e.g., ultraviolet-cured epoxy), pressure sensitive adhesive, or other suitable adhesive. If desired, adhesive may be used to attach diffuser 84 to light-emitting diode 38, as indicated by optional adhesive 98.

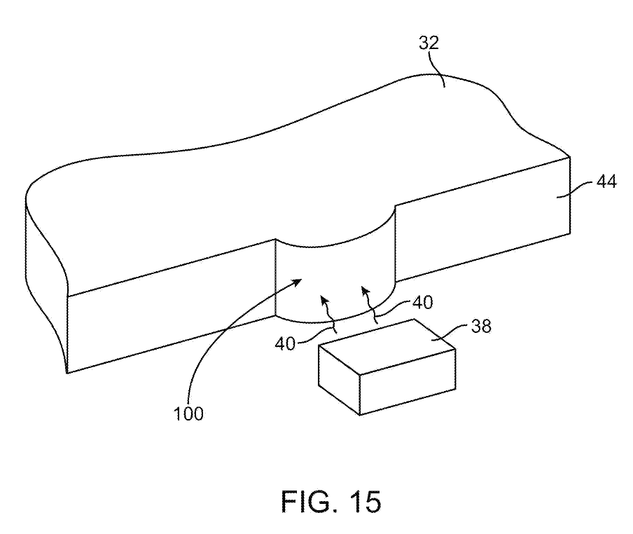

Light-diffracting or light-refracting structures such as angled edge 44 of FIG. 12 may be implemented using other shapes. For example, light 40 from light-emitting diode 38 may be diffracted or refracted and thereby disrupted using a curved portion 100 or other protruding portion of light-guide panel 32, as shown in FIG. 15. Portion 100 may have a curved shape, a sawtooth shape, or other suitable shapes that can diffract or refract light 40 as light 40 passes through edge 44 of light-guide panel 32.

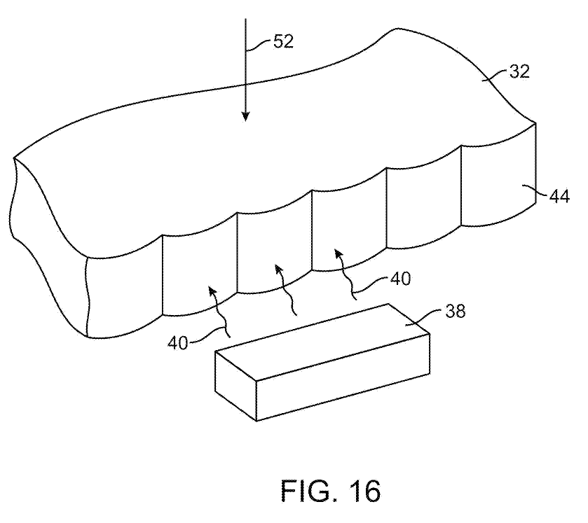

If desired, light-guide panel 32 may have a scalloped edge such as scalloped edge 44 of FIG. 16. This type of edge shape and shapes of the type shown in FIG. 15 may be formed by stamping (as an example). Substantially all of edge 44 may be provided with scallops of the type shown in FIG. 16 or only part of edge 44 may be scalloped. Other light-diffracting or light-refracting patterns may be used on edge 44 in addition to or instead of using scallops. For example, edge 44 may be provided with a sawtooth profile (when viewed in direction 52.

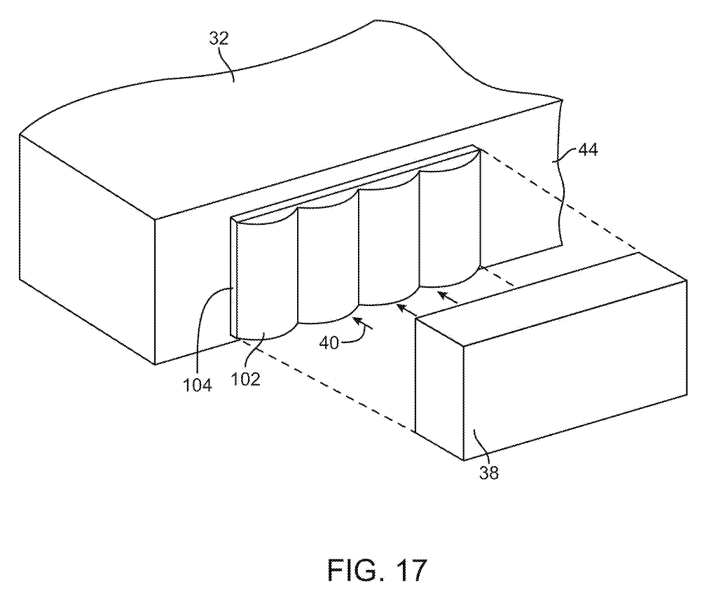

FIG. 17 is a perspective view of a portion of light-guide panel 32 showing how a light-diffracting or light-refracting structure may be implemented using a separate structure that is attached to edge 44 of light-guide panel 32. As shown in FIG. 17, light-diffracting or light-refracting structure 102 may be attached to edge 44 of light-guide panel 32 using adhesive 104 (as an example). Light-diffracting or light-refracting structure 102 may have a scalloped edge shape (as shown in FIG. 17), a sawtooth edge shape, or other suitable light-diffracting configuration. Light-diffracting or light-refracting structure 102 may, if desired, be formed as part of a long strip of material that runs along the entire length of edge 44. Adhesive 104 (e.g., liquid adhesive or pressure sensitive adhesive) may be interposed between structure 102 and edge 44 or other attachment structures may be used to affix light-diffracting or light-refracting structure 102 within display 14.

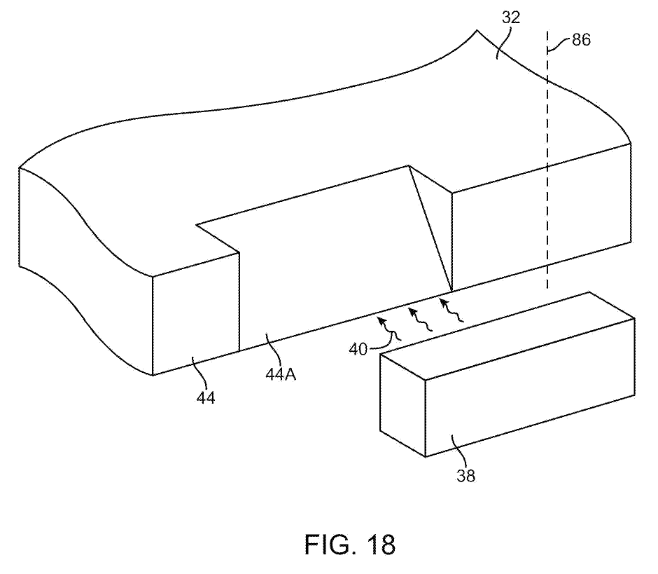

As shown in FIG. 18, a section of edge 44 (i.e., section 44A) may be angled at a non-zero angle (see, e.g., FIG. 12) with respect to axis 86, rather than orienting the entire edge 44 at a non-zero angle.

If desired, combinations of light-disrupting structures (e.g., light-diffusing structures and/or light-diffracting or light-refracting structures) and color-filtering edge reflectors may be used. For example, a light diffuser or light-diffracting or light-refracting structure may be provided on edge 44 of light-guide panel 32 to help disrupt light rays 40 and ensure that the light that reaches edge 54 of light-guide panel is less blue-intensive, while simultaneously implementing edge reflector 34 using a material or group of materials that give rise to a blue-absorbing reflection spectrum (as shown in FIG. 8).

The foregoing is merely illustrative of the principles of this invention and various modifications can be made by those skilled in the art without departing from the scope and spirit of the invention.

What is claimed is:

1. A display, comprising:
display structures that include an array of image pixels; and
a backlight for the display, wherein the backlight includes a light guide panel and an edge reflector along an edge of the light-guide panel and wherein the edge reflector absorbs more light at shorter visible wavelengths than at longer visible wavelengths.

2. The display defined in claim 1 wherein the edge reflector comprises a layer of material impregnated with a colored substance.

3. The display defined in claim 2 wherein the layer of material comprises paper.

4. The display defined in claim 3 wherein the colored substance comprises dye.

5. The display defined in claim 4 wherein the colored substance comprises yellow dye.

6. The display defined in claim 1 wherein the edge reflector comprises a first layer of material and a second layer of material.

7. The display defined in claim 6 wherein the first layer of material comprises a colored filter and wherein the second layer of material comprises a reflective substrate material.

8. The display defined in claim 6 wherein the first layer of material comprises a yellow filter layer and wherein the second layer of material comprises a reflective substrate.

9. The display defined in claim 1 further comprising light-emitting diodes that emit light, wherein the light-guide panel has opposing first and second edges, wherein the emitted light from the light-emitting diodes is injected into the first edge and wherein the edge reflector is adjacent to the second edge.

10. The display defined in claim 9 wherein the edge reflector comprises a colored material that absorbs more blue light than yellow light.

11. The display defined in claim 1 further comprising:
light-emitting diodes that emit light; and
a light-disrupting structure interposed between the light-emitting diodes and the light-guide panel that disrupts light emitted from the light-emitting diodes.

12. Display backlight structures, comprising:
a light-emitting diode that emits light;
a light-guide panel that has opposing first and second edges, wherein the first edge receives light emitted from the light-emitting diode; and
a reflector that reflects more yellow light than blue light, wherein the reflector reflects light into the light-guide panel at the second edge of the light-guide panel.

13. The display backlight structures defined in claim 12 further comprising a light-disrupting structure that is interposed between the light-emitting diode and the first edge of the light-guide panel and that disrupts light emitted from the light-emitting diode.

14. The display backlight structures defined in claim 12 further comprising a light diffuser that is interposed between the light-emitting diode and the first edge of the light-guide panel and that diffuses light emitted from the light-emitting diode.

15. The display backlight structures defined in claim 12 wherein the light-emitting diode includes a substrate lying in a plane, the display backlight structures 5 further comprising a light-diffracting structure having a surface oriented at a non-zero angle with respect to the plane.

16. The display backlight structures defined in claim 15 wherein the light-diffracting structure comprises a portion of the light-guide panel.

17. The display backlight structures defined in claim 16 wherein the light-diffracting structure comprises a plastic member that is separate from the light-guide panel.

18. The display backlight structures defined in claim 12 wherein the light-emitting diode includes a substrate lying in a plane, the display backlight structures further comprising a light-refracting structure having a surface oriented at a non-zero angle with respect to the plane.

19. The display backlight structures defined in claim 18 wherein the light-refracting structure comprises a portion of the light-guide panel.

20. The display backlight structures defined in claim 19 wherein the light-refracting structure comprises a plastic member that is separate from the light-guide panel.

21. Display backlight structures for a liquid crystal display, comprising:
light-emitting diodes that emit light;
a light-guide panel that has opposing first and second edges, wherein the first edge receives light emitted from the light-emitting diodes; and
a reflector that is disposed along the second edge and that reflects more yellow light than blue light.

22. The display backlight structures defined in claim 21 wherein the reflector comprises a reflective substrate containing a substance that absorbs more blue light than yellow light.

23. The display backlight structures defined in claim 22 further comprising a diffuser that is attached to the first edge with adhesive.
